(19) United States
(12) Patent Application Publication
(10) Pub. No.: US 2025/0064086 A1
(43) Pub. Date: Feb. 27, 2025

(54) MEAT ANALOGUE PRODUCT

(71) Applicant: DSM IP ASSETS B.V., Heerlen (NL)

(72) Inventors: Linda DE LANGE, ECHT (NL); Stéphanie Cécile Caroline AVRIL, ECHT (NL)

(21) Appl. No.: 18/549,276

(22) PCT Filed: Mar. 17, 2022
(86) PCT No.: PCT/EP2022/057004

§ 371 Date: Sep. 6, 2023

(30) Foreign Application Priority Data
Mar. 19, 2021 (EP) 21163615.4

(51) Int. Cl. A23J 3/22; A23J 3/14

(52) U.S. Cl. CPC A23J 3/227; A23J 3/14

(57) ABSTRACT

The present invention relates to a meat analogue product comprising a texturized vegetable protein, a binder, a flavor and 0.5 to 10% (w/w) of a rapeseed protein isolate comprising napins and cruciferins, wherein the rapeseed protein isolate comprising napins and cruciferins is not texturized.

### FIELD

The invention relates to a meat analogue product and to a method for preparing thereof. The present invention also relates to the use of rapeseed protein isolate.

### BACKGROUND OF THE INVENTION

Meat analogues become abundantly available following the increasing need in the market for vegetarian products. Meat analogue hamburgers for example are developed that closely mimic the texture and taste of real meat hamburgers. Plant protein is the common ingredient in most meat analogue products. Challenges of using plant protein instead of animal protein is to provide a good texture that is perceived as a real meat. For example a challenge is to produce a meat analogue product having an improved fat and moisture retention upon cooking the meat analogue product. For example, a ground meat patty, when cooked by baking, grilling or pan frying loses part of its moisture and undergoes a weight loss. This weight loss results in shrinkage of the cooked meat product. The total moisture loss in any meat due to the cooking out of the natural juices is an inevitable consequence of the cooking process and leading to reduction of perceived juiciness.

WO2006034172 discloses a soy protein fraction and reports that soy absorbs fat, thereby decreasing fatting out the fat in the process of cooking. Reported cook yields are still only ˜90-93%.

Wi et al. Evaluation of the physicochemical and structural properties and the sensory characteristics of meat analogues prepared with various non animal based liquid alternatives, MDPI, Foods 2020, 9, 461, discloses a study on meat analogues comprising texturized vegetable protein, soy protein isolate and other liquid additives. The articles shows that water+soy protein isolate results in a cooking loss of 12 to 14%.

Hence, besides soy is allergenic and undesired for meat alternatives, there is a need in the art for further improved fat and moisture retention in meat analogue products.

Further, a challenge is to provide a meat analogue product having a visual appearance upon cooking, like colour and crust formation that closely mimics real meat products. Therefore, there is a need in the art for meat analogue products that provide a good texture and provide a cooking experience closely mimicking the experience of real meat products.

### DETAILED DESCRIPTION OF THE INVENTION

This object, amongst other objects is solved by providing a meat analogue product according to the appended claims.

Specifically, the present invention relates to a meat analogue product comprising a texturized vegetable protein, a binder, a flavor and 0.5 to 10% (w/w) of a rapeseed protein isolate comprising napins and cruciferins, preferably wherein the rapeseed protein isolate comprising napins and cruciferins is not texturized.

Surprisingly, the present inventors found that meat analogue products comprising rapeseed protein isolate on top of the texturized vegetable protein used for giving texture, have a reduced weight loss upon cooking, have a brownish colour and a crust formation that closely mimics real meat products.

The term ‘meat analogue product’, or meat substitute, as used in the present context means a product that does not comprise animal protein and thus is suitable to be used as a vegetarian or vegan meat alternative product and has an appearance mimicking an animal meat-based product.

The term ‘protein isolate’ as used in the present context means a protein product having more than 85% proteins on dry basis of proteins, preferably around 90% on dry basis. Preferably, the rapeseed protein isolate has a protein content of at least 90 wt. % (calculated as Kjeldahl N×6.25) on a dry weight basis, more preferably at least 94 wt. %, most preferably at least 96 wt. % and especially at least 98 wt. %.

In an embodiment, the present rapeseed protein isolate comprising napins and cruciferins is not texturized and/or hydrated. Hence, the napins and cruciferins are preferably not texturized and/or hydrated. Preferably the present rapeseed protein isolate is a powder, or is in powder form, having a dry matter of higher than 90 wt. % such as higher than 91 wt. %, or 92 wt. %.

In an embodiment, the present rapeseed protein isolate comprises 40-65% (w/w) cruciferins and 35-60% (w/w) napins, or wherein the rapeseed protein comprises 70-99% (w/w) cruciferins and 1-20% (w/w) napins, or wherein the rapeseed protein comprises 1-20% (w/w) cruciferins and 70-99% (w/w) napins, wherein the sum of cruciferins and napins is not exceeding 100% (w/w).

In an embodiment the present rapeseed protein isolate is low in anti-nutritional factors and contains less than 1.5% (w/w) phytate, preferably less than 0.5% (w/w) phytate, and is low in glucosinolates (<5 μmol/g) and low in phenolics (<10 mg/g). In an embodiment the rapeseed protein isolate has a high solubility of at least 88% when measured over a pH range from 3 to 10. In an embodiment the rapeseed protein isolate has a low mineral content, in particular low in sodium, and with that a low conductivity when dissolved in water. This is advantageous as minimizing salt content in food products, i.e. also in meat analogues, is an important topic in addressing improvement of public health. A well-known legume-derived protein isolate like pea protein isolate has a sodium load that is relatively high. In contrast, rapeseed protein may have a conductivity in a 2 wt. % aqueous solution of less than 9 mS/cm over a pH range of 2 to 12, for example of from 0.5-9 mS/cm, or from 1-7 mS/cm or 4±3 mS/cm.

In an embodiment, the present rapeseed protein isolate and/or the present meat analogue product does not comprise gluten or gliadin, i.e. the meat analogue product is so called gluten free. By gluten free is meant that the meat analogue product comprises less than 20 ppm of gluten and more preferably less than 10 ppm of gluten. Gluten is usually measured by measuring the gliadin content, for example as described in WO 2017/102535. Therefore, according to the present invention there is provided a gluten free meat analogue product comprising less than 10 ppm gliadin.

Preferably, the present rapeseed protein isolate comprises native napins and cruciferins. Native means that (substantially all) the napins and cruciferins are in their non-denatured state. Further, the napins and cruciferins are preferably not hydrolyzed, such as not enzymatically hydrolyzed.

In a preferred embodiment, the present rapeseed protein (isolate) comprises 40 to 65 wt. % cruciferins and 35 to 60 wt. % napins (of the rapeseed protein). Preferably, the present rapeseed protein comprises 40 to 55 wt. % cruciferins and 45 to 60 wt. % napins.

In a preferred embodiment, the present rapeseed protein (isolate) comprises 60 to 85 wt. % cruciferins and 20 to 40 wt. % napins. Preferably, the present rapeseed protein comprises 65 to 75 wt. % cruciferins and 25 to 35 wt. % napins.

In a preferred embodiment, the present rapeseed protein (isolate) comprises 0 to 20 wt. % cruciferins and 80 to 100 wt. % napins. Preferably, the present rapeseed protein comprises 0 to 10 wt. % cruciferins and 90 to 100 wt. % napins. Preferably, the present rapeseed protein comprises 1 to 5 wt. % cruciferins and 95 to 100 wt. % napins.

Preferably, the amounts of cruciferins and napins are determined by size exclusion chromatography (SEC). Preferably, the amounts of cruciderins and napins are determined by size exclusion chromatography (SEC) using the following test:

samples of protein isolate are dissolved in a 500 mM NaCl saline solution and analyzed by High Performance SEC using the same solution as the mobile phase, followed by detection using measuring UV absorbance at 280 nm, wherein the relative contribution of cruciferin and napin (wt. %) was calculated as the ratio of the peak area of each protein with respect to the sum of both peak areas.

Preferably, the present rapeseed protein (isolate) comprises 40 to 65 wt. % 12S and 35 to 60 wt. % 2S. Preferably, the present rapeseed protein comprises 40 to 55 wt. % 12S and 45 to 60 wt. % 2S.

In a preferred embodiment, the present rapeseed protein (isolate) comprises 60 to 85 wt. % 12S and 20 to 40 wt. % 2S. Preferably, the present rapeseed protein comprises 65 to 75 wt. % 12S and 25 to 35 wt. % 2S.

In a preferred embodiment, the present rapeseed protein (isolate) comprises 0 to 20 wt. % 12S and 80 to 100 wt. % 2S. Preferably, the present rapeseed protein comprises 0 to 10 wt. % 12S and 90 to 100 wt. % 2S. Preferably, the present rapeseed protein comprises 1 to 5 wt. % 12S and 95 to 100 wt. % 2S.

Preferably, the amounts of 12S and 2S is determined by sedimentation velocity analytical ultracentrifugation (SV-AUC) analysis. Preferably, the amounts of 12S and 2S is determined by sedimentation velocity analytical ultracentrifugation (SV-AUC) analysis using the following test:

samples of protein isolate are dissolved in a 3.0% (or 500 mM) NaCl saline solution and amounts determined using interference optics.

In a preferred embodiment, the present rapeseed protein (isolate) comprises a conductivity in a 2 wt. % aqueous solution of less than 9000 μS/cm over a pH range of 2 to 12. More preferably the conductivity of the native rapeseed protein isolate in a 2 wt. % aqueous solution is less than 4000 μS/cm over a pH range of 2.5 to 11.5. For comparison the conductivity of a 5 g/l NaCl aqueous solution is around 9400 μS/cm. Preferably conductivity is measured with a conductivity meter, for example Hach sensION+EC71.

In an embodiment, the present rapeseed protein has an enthalpy of denaturation in the hydrated state (AH value) of around 0, for example of from 0 to 1 J/g or of 0±0.5 J/g. The AH value may be established for example by measuring a 40% (w/w) solution or dispersion of rapeseed protein isolate in water by means of Differential Scanning calorimetry (DSC). This enthalpy of denaturation can be the result of cooking the meat analogue product. Native rapeseed protein isolate usually has an enthalpy of denaturation in the hydrated state of from 1 to 10 J/g, or of from 2 to 6 J/g of a 40% (w/w) protein solution.

In an embodiment the rapeseed protein isolate has a DIAAS value in older children, adolescents and adults aged 3 yr. and older which is equal to or higher than 100. In an embodiment the DIAAS value is from 100 to 200, or from 105 to 150, or from 110 to 135. For example, the DIAAS value may be 110±10.

In the context of the present invention the term “DIAAS” refers to Digestible Indispensable Amino Acid Score and is calculated as recommended by the Food and Agriculture Organization of the United Nations (Report of an Expert Consultation (2013) of the Food and Agriculture Organization of the United Nations (FAO); Dietary Protein Quality Evaluation in Human Nutrition) using equation DIAAS (%)=100×lowest value of the DIAA reference ratio. The DIAAS values may be calculated for different age groups and in the context of the present invention this is done according to the above FAO recommendation for 3 different age groups. These are infants (from birth to 6 mo.), children (from 6 mo. to 3 yr.), and older children, adolescents and adults (≥3 yr.).

The term “DIAA reference ratio” refers to Digestible Indispensable Amino Acid reference ratio and is calculated according to Cervantes-Pahm et al. (Br. J. Nutr. (2014) 111:1663-1672) using equation DIAA reference ratio=digestible indispensable amino acid content in 1 g protein of food (mg)/mg of the same dietary indispensable amino acid in 1 g of the reference protein.

In an embodiment, the present rapeseed protein isolate has a DIAAS value, preferably a DIAAS value in older children, adolescents and adults aged 3 yr. and older, which is equal to or higher than 100. In an embodiment the DIAAS value is from 100 to 200, or from 105 to 150, or from 110 to 135. For example, the DIAAS value may be 110±10. Preferably, the DIAAS value is from 101 to 130, or from 102 to 125, or from 103 to 120, or from 103 to 115.

It was found that heat-treated rapeseed protein has superior DIAAS values compared to other plant-derived proteins. As is shown in the experimental part, cooking temperatures might denature the protein and increase the DIAAS value. This is advantageous for the meat analogue product according to the present invention, as they have a beneficial nutritional value.

Therefore, in a preferred embodiment, the present invention relates to a meat analogue product, wherein the rapeseed protein (isolate) has a DIAAS value of which is equal to or higher than 100. In an embodiment the DIAAS value is from 100 to 200, or from 105 to 150, or from 110 to 135. For example, the DIAAS value may be 110±10. Preferably, the DIAAS value is from 101 to 130, or from 102 to 125, or from 103 to 120, or from 103 to 115.

Given the identified reduced weight loss and improved fat and moisture retention of the present meat analogue product, the present meat analogue product has in an embodiment after cooking a weight loss of the meat analogue product being less than 2%. This weight loss can be easily determined by weighting the meat analogue product before and after cooking and calculating the percent of weight loss. Cooking as used in the present context means the final heating step before consumption of the present meat analogue product. Examples of cooking is for example pan frying. Preferably, the weight loss is less than 1.5%, or less than 1%. Alternatively, the cooking loss can be determined by collecting the juices after frying, measuring the weight of the lost juices and calculating the of weight loss as percentage of the weight of the raw (=uncooked) meat analogue product.

The present meat analogue product comprises texturized vegetable protein. Preferably the texturized vegetable protein is an extruded vegetable protein product. This can cause a change in the structure of the protein which results in a fibrous, spongy matrix, similar in texture to meat. The textured vegetable protein can be rehydrated or dehydrated. Preferably, the texturized vegetable protein is selected from soy bean protein, pea protein, lentil protein, lupin bean protein, wheat gluten, rapeseed protein, fava bean protein or a combination thereof. Given that soy is an allergen, it is preferred that the present texturized vegetable protein is soy free. Preferably the present meat analogue product is soy free.

Preferably, the present meat analogue product comprises texturized vegetable protein in an amount from 5 to 30% (w/w), preferably an amount of 6 to 25% (w/w), preferably 8 to 20% (w/w), preferably 10 to 15% (w/w) of the meat analogue product.

Preferably, the present meat analogue product comprises texturized vegetable protein with a protein amount from 50 to 99% (w/w), preferably an amount of 55 to 90% (w/w), preferably 60 to 85% (w/w) of the texturized vegetable protein.

Preferably, the present texturized vegetable protein is hydrated towards an amount of water of more than 10% (w/w) of the texturized vegetable protein, preferably an amount of water from 20 to 80% (w/w) of the texturized vegetable protein, preferably an amount of water from 30 to 70% (w/w) of the texturized vegetable protein. In an embodiment, the present binder is chosen from the group consisting of gellan gum, methylcellulose, egg white, wheat gluten, fermented protein, beta-glucan, calcium-alginate gels and starch based binders, or a combination thereof.

The term “binder” or “binding agent” as used herein relates to a substance for holding together particles and/or fibres in a cohesive mass. It is an edible substance that in the final product is used to trap components of the foodstuff with a matrix for the purpose of forming a cohesive product and/or for thickening the product. Binding agents of the invention may contribute to a smoother product texture, add body to a product, help retain moisture and/or assist in maintaining cohesive product shape; for example by aiding particles to agglomerate. Preferably the present meat analogue product comprises an amount of binder from 0.5 to 5% (w/w), preferably from 1 to 4% (w/w), such as from 2 to 3% (w/w).

The binder may be methyl cellulose. The methyl cellulose might be present in an amount of 0.5 to 2% (w/w) such as from 1 to 2% (w/w) of the meat analogue product.

In a preferred embodiment the binder is gellan gum and the present gellan gum is high acyl gellan gum. Preferably the high acyl gellan gum is a polymer comprising various monosaccharides linked together to form a linear primary structure and the gum gels at temperatures of greater than 60 degrees centigrade. In some high acyl gellan gums, the gel temperature may be approximately 70 degrees centigrade or greater. In some high acyl gellan gums, the gel temperature may be approximately between 70 degrees centigrade and 80 degrees centigrade The properties of the high acyl gellan gum polymer may vary depending at least in part on its source, how it was processed, and/or the number and type of acyl groups present on the polymer.

Preferably, the amount of gellan gum in the present meat analogue product is within the range of 0.1 to 4% (w/w), preferably 0.2 to 3% (w/w), more preferably 0.5 to 1.0% (w/w) of the meat analogue product.

Preferably, the present gellan gum, or the present high acyl gellan gum, has a single gel setting temperature that is within the range of 70° C. to 90° C. The advantage of high acyl gellan gum is that it forms soft and flexible gels, beneficial in providing a good texture of a vegetarian emulsified meat product, without introducing off flavors to the product. Preferably, the present gellan gum, or the present high acyl gellan gum, has more than 40% acetyl and more than 45% glyceryl residual substitutions per repeating unit.

In a preferred embodiment, the present meat analogue product further comprises a nutrient, preferably wherein the nutrient comprise both vitamins and minerals, preferably vitamins chosen from the group consisting of B2, B3, B6 and B12, preferably minerals chosen from the group consisting of iron, selenium and zinc. The term “nutrient” as used herein relates to a substances that provide nutritional value to the present meat analogue product, such as vitamins, minerals, trace elements and antioxidants for example. The advantage of adding these nutrients is that the present meat analogue product more closely resembles the nutritional value of a real meat hamburger, without introducing oft flavors to the meat analogue product.

In an embodiment, the present meat analogue product further comprises a vegetable oil and/or a vegetable fat. The vegetable oil and/or fat can be an algal oil, a fungal oil, corn oil, olive oil, soy oil, peanut oil, walnut oil, almond oil, sesame oil, cottonseed oil, rapeseed oil, canola oil, safflower oil, sunflower oil, flax seed oil, palm oil, palm kernel oil, coconut oil, babassu oil, shea butter, mango butter, cocoa butter, wheat germ oil, borage oil, black currant oil, sea-buckhorn oil, macadamia oil, saw palmetto oil, conjugated linoleic oil, arachidonic acid enriched oil, docosahexaenoic acid (DHA) enriched oil, eicosapentaenoic acid (EPA) enriched oil, palm stearic acid, sea-buckhorn berry oil, macadamia oil, saw palmetto oil, or rice bran oil; or margarine or other hydrogenated fats. In some embodiments, for example, the oil is algal oil. In a preferred embodiment, the present plant oil is sunflower oil and/or the present plant fat is coconut fat.

Preferably, the amount of vegetable oil is within the range from 2 to 20% (w/w) of the meat analogue product, such as from 5 to 15% (w/w) or from 7 to 12% (w/w). Preferably, the amount of vegetable fat is within the range from 0.5 to 5% (w/w) of the meat analogue product, such as from 1 to 3% (w/w) of the meat analogue product.

In an embodiment, the amount of (non texturized and/or non hydrated) rapeseed protein isolate comprising napins and cruciferins is from 1 to 9% (w/w), preferably from 1 to 8% (w/w) of the meat analogue product, such as from 1.5 to 7 or 2 to 6% (w/w) of the meat analogue product.

In an embodiment, the present meat analogue product comprises from 1 to 5% (w/w) of a pea protein isolate. The present inventors found that addition rapeseed protein isolate creates meat analogue products having an improved brownish colour and reduced weight loss, also when combined with addition of pea protein isolate. Preferably the pea protein isolate is not texturized and/or hydrated.

In an embodiment, the present meat analogue product comprises from 1 to 30% (w/w), preferably 1 to 20% (w/w) of rapeseed protein. Preferably this 1 to 30% (w/w) or 1 to 20% (w/w) is the total of rapeseed protein in the present meat analogue product. Hence, this includes for example the protein in the texturized vegetable protein and the added present rapeseed protein isolate.

In an embodiment, the present meat analogue product comprises from 1 to 30% (w/w), preferably 1 to 20% (w/w) of pea protein.

In an embodiment, the present meat analogue product comprises from 1 to 30% (w/w), preferably 1 to 20% (w/w) of soy protein.

In an embodiment, the present meat analogue product is a hamburger (or patty), a minced meat, a ball or a sausage. Preferably a hamburger.

In a preferred embodiment the present meat analogue product comprises a flavor or flavor agent, or flavor precursor. Examples of flavors can be yeast extracts or process flavours. More preferably the present meat analogue product comprises 0.001 to 5% (w/w) of a flavor.

In an embodiment the present meat analogue product comprises a flavor modifier or a flavoring with modifying properties. More preferably the present meat analogue product comprises 0.001 to 1% (w/w) of a flavor modifier or a flavoring with modifying properties. An example is Modumax© from DSM. Modumax© is preferably a flavour composition comprising glucans, mannans, amino acids, proteins, protein fragments and phospholipids. Preferably comprising:
(i) 10 to 40% (w/w) glucans;
(ii) 5 to 30% (w/w) mannans;
(iii) 5 to 30% (w/w) free amino acids;
(iv) 10 to 40% (w/w) protein; and
(v) 5 to 25% (w/w) phospholipids.

Preferably, the present meat analogue product comprises salt, preferable NaCl. The amount of salt is preferably within the range of 0.001 to 5% (w/w) of the present meat analogue product.

In a preferred embodiment, the present meat analogue product comprises a colorant, preferably within the range of 0.01 to 10 wt. %, more preferably 0.1 to 5 w. %, most preferably 0.2 to 2 wt. % of the meat analogue product. In a preferred embodiment, the present colorant comprises or is beet root or beet root powder. The advantage of using beet root is that a meaty like color is provided to the product, without introducing off flavors to the product. The present colorant can also be or comprise a carotenoid. Preferably, the carotenoid is chosen from the group consisting of α- or ß-carotene, 8′-apo-ß-carotenal, 8′-apo-ß-carotenoic acid esters such as the ethyl ester, bixin, capsanthin, capsorubin, rhodoxanthin, canthaxanthin, astaxanthin, astaxanthin esters, lycopene, lutein, zeaxanthin or crocetin and their derivatives.

In an embodiment the present meat analogue product comprises a heme, a heme protein, a heme containing protein or a (macro) molecule with complexed iron. More preferably the present meat analogue product comprises 0.001 to 5% (w/w) of a heme, a hem protein, a heme containing protein or a (macro) molecule with complexed iron.

In an embodiment, the present meat analogue product comprises an amount of water within the range of 50 to 80% (w/w), preferably 55 to 70% (w/w).

In a second aspect the present invention relates to a method for preparing a meat analogue product, comprising a step of preparing a dough, and adding 0.5 to 10% (w/w) of a rapeseed protein isolate comprising napins and cruciferins to the dough and shaping the dough into a meat analogue product, preferably wherein the rapeseed protein isolate comprising napins and cruciferins is not texturized (and/or hydrated). Preferably the present method further comprises freezing the shaped meat analogue product. Preferably the meat analogue product is as defined herein. Preferably the rapeseed protein isolate is as defined herein. Preferably the dough comprises a texturized vegetable protein and a binder, preferably as defined herein.

In a third aspect the present invention relates to the use of the present rapeseed protein isolate comprising napins and cruciferins for browning a meat analogue product or for providing a brown colour or for providing a darker brown colour to a meat analogue product. Or the use of the present rapeseed protein isolate comprising napins and cruciferins for improving the crust formation on a meat analogue product or for creating more crust on a meat analogue product. Or the use of the present rapeseed protein isolate comprising napins and cruciferins for reducing weight loss of a meat analogue product upon cooking.

The present invention is further illustrated using the examples below.

### EXAMPLES

### Example 1 Preparation of Hamburgers

The ingredients as shown in table 1 were used in preparation of the 5 different hamburgers in the following order. First caramelized sugar and beetroot powder were dry mixed separately and then added to the water. This water was used to hydrate texturized pea protein Nutralys TP70G and was left for hydration for at least 45 minutes at room temperature. During those 45 minutes, the product was mixed for 15 seconds every 15 minutes, using a Hobart kitchen machine. To prepare the emulsion, first the gellan gum, methylcellulose and oil were mixed in a Magi mix for 45 seconds at fixed speed. Then the ice-cold water was slowly added while mixing under high shear. At this stage the paste like emulsion was ready and subsequently hand mixed with the hydrated TVP until homogenous appearance of the dough. Finally, the dry parts the flavors, rapeseed protein isolate (RPI) and/or pea protein isolate (PPI) and salt were mixed in the dough, followed by the frozen coconut fat chunks.

The homogenous dough was chilled for 1 hour in the fridge. Hamburgers of 130 grams each where subsequently shaped with use of a mould. The hamburgers were blast frozen for 90 minutes and then transferred to a normal freezer. The hamburgers were stored in the freezer for at least 3 nights before use. The day before the cooking the hamburgers were removed from the freezer and placed in the fridge to thaw. The starting temperature of the burgers before cooking was 7° C. A grill plate was set at 160° C., and burgers were cooked for 7 minutes at one site until core temperature was 75° C., then the burger was turned around and cooked for another 7 minutes at the other site. A set of 3 burgers obtained from same dough having equal levels of RPI/PPI were cooked simultaneously.

TABLE 1

| | 0% RPI | 6% RPI | 3% RPI | 2% RPI | 4% RPI |
|---|---|---|---|---|---|
| Ingredients (in weight %) | 6% PPI | 0% PPI | 3% PPI | 4% PPI | 2% PPI |
| Textured Pea Protein | 13.17 | 13.17 | 13.17 | 13.17 | 13.17 |
| Nutralys TP70G from | | | | | |
| Roquette | | | | | |
| Caramelized sugar ncs | 0.12 | 0.12 | 0.12 | 0.12 | 0.12 |
| 23p from Buisman | | | | | |
| Beet root from Diana | 0.24 | 0.24 | 0.24 | 0.24 | 0.24 |
| water 1 (hydration) | 30.98 | 30.98 | 30.98 | 30.98 | 30.98 |
| Gellan Gum HA | 0.6 | 0.6 | 0.6 | 0.6 | 0.6 |
| (GellaneerHD ™ from | | | | | |
| DSM) | | | | | |
| methylcellulose MX | 1.50 | 1.50 | 1.50 | 1.50 | 1.50 |
| sunflower oil from local | 12 | 12 | 12 | 12 | 12 |
| brand | | | | | |
| water 2 | 30.16 | 30.16 | 30.16 | 30.16 | 30.16 |
| Rapeseed protein | 0 | 6 | 3 | 2 | 4 |
| isolate according to | | | | | |
| WO 2018/007492 | | | | | |
| Pea protein isolate from | 6 | 0 | 3 | 4 | 2 |
| MyProtein | | | | | |
| Salt | 0.73 | 0.73 | 0.73 | 0.73 | 0.73 |
| Flavors | 2.5 | 2.5 | 2.5 | 2.5 | 2.5 |
| Coconut fat | 2 | 2 | 2 | 2 | 2 |
| Total | 100% | 100% | 100% | 100% | 100% |

### Example 2 Fat & Moisture Retention

The hamburgers prepared in example 1 were analysed on the amount of fat/moist loss during cooking. From the series of 5 different hamburgers from each set 3 hamburgers were cooked as described in example 1. The fat/moist that was lost from the hamburgers was collected after cooking. This was done by decanting the grill plate and scraping the fat/moist with a spatula to the end where a tube was held in which all was collected. The weight of the tube was measured before and after collecting of the fat/moist.

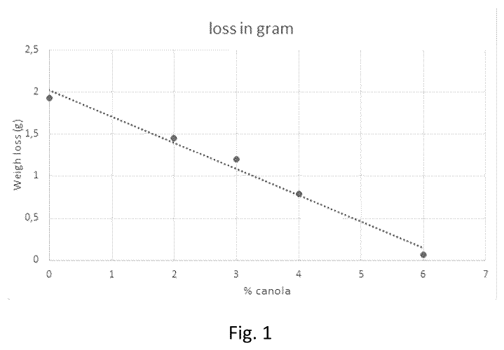

The results are shown in table 2 below and in FIG. 1.

### DSM IP Assets B.V.

TABLE 2

| Type of burger | Fat/moist loss |
|---|---|
| 0% RPI | ++++ |
| 6% PPI | 1.93 g |
| 6% RPI | − |
| 0% PPI | 0.06 g |
| 3% RPI | ++ |
| 3% PPI | 1.19 g |
| 2% RPI | +++ |
| 4% PPI | 1.45 g |
| 4% RPI | + |
| 2% PPI | 0.78 g |

### Example 3 Colour

The raw hamburgers prepared in example 1 were analyzed on the colour using a commercially available colour measure apparatus, that determines the L value of the Cielab color space. The results are show in the table 3 below:

TABLE 3

| Type of burger | Average L |
|---|---|
| 0% RPI | 62.5 +/− 2 |
| 6% PPI | |
| 6% RPI | 49.1 +/− 1.5 |
| 0% PPI | |
| 3% RPI | 55.2 +/− 1.4 |
| 3% PPI | |
| 2% RPI | 55.2 +/− 2.9 |
| 4% PPI | |
| 4% RPI | 52.6 +/− 2.4 |
| 2% PPI | |
| Real meat | 31.8 +/− 1.1 |
| Nestlé Sensational | 53.5 +/− 1.6 |
| burger (soy based) | |

### Example 4 Crust Formation

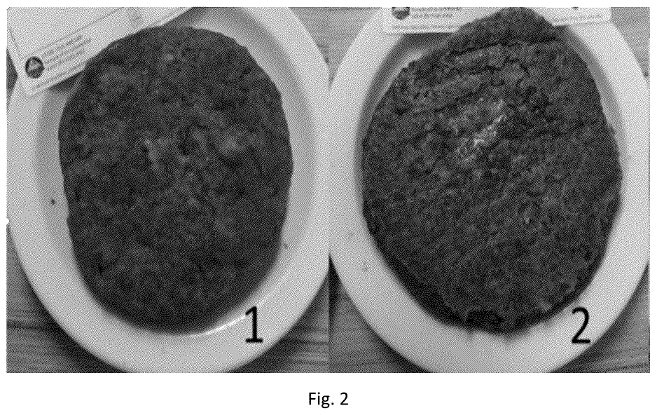

The hamburgers are produced according to example 1. After frying, the thickness of the formed crust was visually inspected. The results are shown in the table 4 below and in FIG. 2. FIG. 2 shows hamburger ‘1’ made with 6% pea protein isolate and hamburger ‘2’ made with 6% rapeseed protein isolate. FIG. 2 shows that hamburger 2 has more/thicker crust than hamburger 1.

TABLE 4

| Type of burger | Crust formation |
|---|---|
| 0% RPI | + |
| 6% PPI | |
| 6% RPI | +++ |
| 0% PPI | |
| 3% RPI | ++ |
| 3% PPI | |
| 2% RPI | + |
| 4% PPI | |
| 4% RPI | ++ |
| 2% PPI | |

### Example 5 Sensory Assessment

The hamburgers are produced according to example 1. The hamburgers were analysed by a trained panel of 4 panellists. The results are shown in the table 5 below:

TABLE 5

| | 0% RPI | 6% RPI | 3% RPI | 2% RPI | 4% RPI |
|---|---|---|---|---|---|
| Attribute | 6% PPI | 0% PPI | 3% PPI | 4% PPI | 2% PPI |
| Juiciness | good | good | good | good | good |
| Direction | Like pea | Astringent | Pea like | neutral | Little |
| Off note | isolate | Liquorice | | | astringency, |
| | | | | | more neutral |
| Strength | Very | Low | Medium | Medium- | Low- |
| of off note | strong | | | high | medium |
| Appear- | Yellow/ | Brownish/ | Brownish/ | Brownish/ | Brownish/ |
| ance | reddish | meat like | yellowish | yellowish | yellowish |

1. A meat analogue product comprising a texturized vegetable protein, a binder, a flavor and 0.5 to 10% (w/w) of a rapeseed protein isolate comprising napins and cruciferins, wherein the rapeseed protein isolate comprising napins and cruciferins is not texturized.

2. The meat analogue product according to claim 1, wherein the rapeseed protein isolate comprising napins and cruciferins is not hydrated.

3. The meat analogue product according to claim 1, wherein the rapeseed protein isolate comprises 40-65% (w/w) cruciferins and 35-60% (w/w) napins, or wherein the rapeseed protein comprises 70-99% (w/w) cruciferins and 1-20% (w/w) napins, or wherein the rapeseed protein comprises 1-20% (w/w) cruciferins and 70-99% (w/w) napins, wherein the sum of cruciferins and napins is not exceeding 100% (w/w).

4. The meat analogue product according to claim 1, wherein after cooking the meat analogue product the weight loss of the meat analogue product is less than 2%.

5. The meat analogue product according to claim 1, wherein the texturized vegetable protein is selected from soy bean protein, pea protein, lentil protein, lupin bean protein, wheat gluten, rapeseed protein, fava bean protein or a combination thereof.

6. The meat analogue product according to claim 1, wherein the binder is chosen from the group consisting of gellan gum, methylcellulose, egg white, wheat gluten, calcium-alginate gels and starch based binders.

7. The meat analogue product according to claim 1, further comprising a nutrient, optionally wherein the nutrient comprises both a vitamin and a mineral, optionally vitamins chosen from the group consisting of B2, B3, B6 and B12, optionally minerals chosen from the group consisting of iron, selenium and zinc.

8. The meat analogue product according to claim 1, further comprising a vegetable oil and/or a vegetable fat.

9. The meat analogue product according to claim 1, wherein the amount of rapeseed protein isolate comprising napins and cruciferins is from 1 to 8% (w/w) of the meat analogue product.

10. The meat analogue product according to claim 1, further comprising from 1 to 5% (w/w) of a pea protein isolate.

11. The meat analogue product according to claim 1, which is a hamburger, a minced meat, a ball or a sausage.

12. The meat analogue product according to claim 1, wherein the meat analogue product is raw and optionally frozen and requires cooking before consumption.

13. A method for preparing a meat analogue product, comprising preparing a dough, and adding 0.5 to 10% (w/w) of a rapeseed protein isolate comprising napins and cruciferins to the dough and shaping the dough into a meat analogue product, wherein the rapeseed protein isolate comprising napins and cruciferins is not texturized.

14. The method according to claim 13, further comprising freezing the meat analogue product.

15. A product comprising rapeseed protein isolate comprising napins and cruciferins for browning a meat analogue product.
